(19) United States
(12) Patent Application Publication
(10) Pub. No.: US 2002/0097280 A1
(43) Pub. Date: Jul. 25, 2002

(54) Apparatus and method of printing on a curved surface with an ink jet printer

(76) Inventors: Bertram Loper, Arlington, TX (US); William C. Smith, Bedford, TX (US); Larry Katzer, San Francisco, CA (US)

Correspondence Address: John E. Vandigriff, 190 N. Stemmons Frwy., Lewisville, TX, 75067, US

(21) Appl. No.: 10/055,321

(22) Filed: Jan. 23, 2002

Related U.S. Application Data
(60) Provisional application No. 60/264,182, filed on Jan. 25, 2001.

(51) Int. Cl. B41J 3/00

(52) U.S. Cl. 347/2

(57) ABSTRACT

An apparatus and method for using of inkjet printing, digital image processing and transmission techniques, and automated surface preparation and post treatment steps to produce memento and souvenir sports images on-demand.

### PRIORITY

Priority is claimed from Provisional Application S No.: 60/264,182, filed Jan. 25, 2001.

### FIELD OF THE INVENTION

The invention relates to printing with inkjet printers, and more particularly to the printing of accurate and high definition images on spherical and curved surfaces.

### BACKGROUND OF THE INVENTION

It is a common desire of sports people to own and to give to associates, mementoes, trophies, and souvenirs of sporting events and sports personalities. To that end, it has been a common practice in sporting goods industries such as golf equipment suppliers, baseball equipment suppliers, and others, to sell their balls and other devices with images that portray the event or personality desired by the buyer.

The present process for printing on such objects utilizes older technologies such as silkscreen or pad printing. In all such cases, the images are produced after the lengthy and costly preparation of hard copy artwork, physical silk screens, pad printing clichés and other mechanical apparatus. Such processes are expensive, slow, and especially expensive if a small quantity of images is desired by the customer.

Today, inkjet printing has progressed to the point that resolutions, inks, surface preparation techniques, and digital transmission of images all combine to make it possible to print these sports images on an on-demand basis.

It is a further desire of the consumer to have an image of his choice portrayed in close juxtaposition to that of the sports personality or event. This desire is nearly impossible to fulfill, due to costs, for other than the most extravagant, with such methods as silk-screening and pad printing. It is a further desire that the image or combination of images be available to the consumer with much shorter delivery times as compared the current process such silkscreen or pad printing. It is a further desire that the image purchased by the consumer be unique or of limited numbers. Processes such as silk-screening and pad printing make fulfillment of such desires economically infeasible.

The process by which such images can be printed and supplied to consumers is the object of this invention. Today, inkjet printing has progressed to the point that resolutions, inks, surface preparation techniques, and digital transmission of images all combine to make it possible to print high-quality images on an on-demand basis.

U.S. Pat. No. 5,835,106 defines a printing system for printing on a circular container. An ink jet printer prints at specific positions on the circumference of the circular container previously printed on by a transfer drum.

U.S. Pat. No. 5,831,641 defines a method and apparatus for imprinting images on a non-planar surface. The apparatus maintains the surface of article to be printed within a substantially parallel position with respect to the ink jet printer.

U.S. Pat. No. 6,179,732 defines a method of applying markings to the surface of a golf ball.

### SUMMARY OF THE INVENTION

An apparatus and method is presented that encompasses the transmission of an image from a person to an internet web site and the image is then either enhanced or not and subsequently sent via a high speed data ink to a machine that includes one or all of the following steps: Processing the digital image to prepare it for use by the process, sending the digital image to an inkjet printer, using an automated process to prepare a spherical sports object to receive the image onto its surface, inkjet printing the image on the surface of the object in a programmable and variable sequence, drying or curing the image during intermediate steps of the inkjet printing process, and post-treating the inkjet image on the spherical object. Other variations of the process are also described herein. This invention describes the use of inkjet printing, digital image processing and transmission techniques to produce souvenir images on-demand.

### BRIEF DESCRIPTIONS OF THE DRAWINGS

FIG. 1 is an Internet and Data Transmission Block Diagram;

FIG. 2 is an end view of a first embodiment of an apparatus for printing on a curved surface;

FIG. 3 is a front view of the first embodiment

FIG. 4 is a view of a rotated position of the ink jet head of FIG. 2;

FIG. 4 is an isometric view of the first embodiment of an apparatus for printing on a curved surface;

FIG. 6 is a top view of a second embodiment of the invention;

FIG. 7 is a side view of the second embodiment;

FIGS. 8a and 8b are end and side views of a third embodiment of the invention;

FIGS. 9a and 9b are two parts of a process flow chart for programing the printer to print on the curved surface; and

FIG. 10 illustrates a possible user/computer interface for inputing the printing parameters.

### DESCRIPTION OF A PREFERRED EMBODIMENT

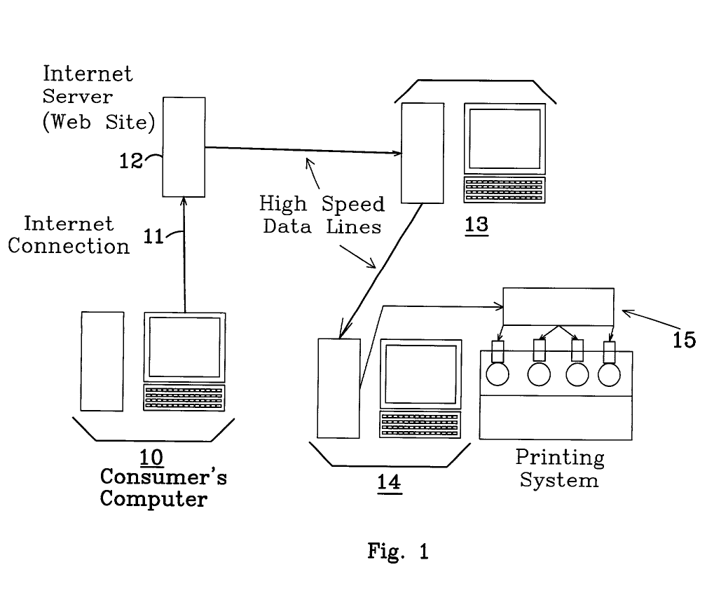

While present methods require the delivery of hardcopy artwork and preparation of physical apparatus such as photographic artwork, silk screens or pad printing clichés, this invention provides for producing and sending a digital image from a consumer's computer 10. The images are delivered via the internet 11 to a website 12 that, in turn, transmits digital images to an image processing work station computer 13. The processed image is then transmitted to a printing system computer 14 which controls and an inkjet printing system as illustrated in FIG. 1.

After receipt, by the web site 12, of the image supplied by the customer, the image is transmitted to an image processing workstation 13 where it is prepared using commercial software such as PhotoShop® or Corel Photo Paint®. Part of the preparation steps is to separate the image into process color planes—cyan, magenta, yellow and black. Other steps may include image touch-up, sizing, or cropping. Then the image is placed in the data queue for transmission to a printing system 14, 15. When the image is received by the printing system 15, it will be printed in the sequence of the queue and in the quantity specified by the website. Optionally, invoicing and shipping papers will automatically be prepared.

The printing process can follow a variety of embodiments some steps of which may be excluded or used, depending upon the surface to be printed on and the type of image requested. Once the image is entered into the print queue of the printing system, the following steps may be followed.

Layering: A unique feature of the special software prepared for this invention includes the use of image layers. In particular, depending upon the surface and ink properties, it may be advantageous to only print part of the ink, then to pause while the ink dries or is cured, and then to print additional ink with additional pauses until the entire amount of ink of a particular color is ultimately deposited on the surface of the object. The partial printing, pausing, drying, and curing is termed for purposes of this description “layering”. Layering can be programmed to optimize the quality of the image that is produced by a given ink and color of ink on a particular surface. The layering process will be determined for each combination of ink and surface and it will is automatically caused to happen according to the software of the system and the control information included with the customer's image file.

Incrementing: Another feature of the special software prepared for this invention is that the layers can be further separated into segments or bands that allow multiple print passes over the same surface by different jets so that if a number of jets are malfunctioning, subsequent jets will cover the error. In so doing, the image quality is preserved even when a number of jets are malfunctioning. The incrementing process will be determined for optimum productivity and will be automatically caused to happen according to the software of the system and the control information included for the ink being used. Incrementing allows extended operation time between maintenance periods.

Embodiment 1: Moving Curved Objects and Spatially Fixed Printing Devices.

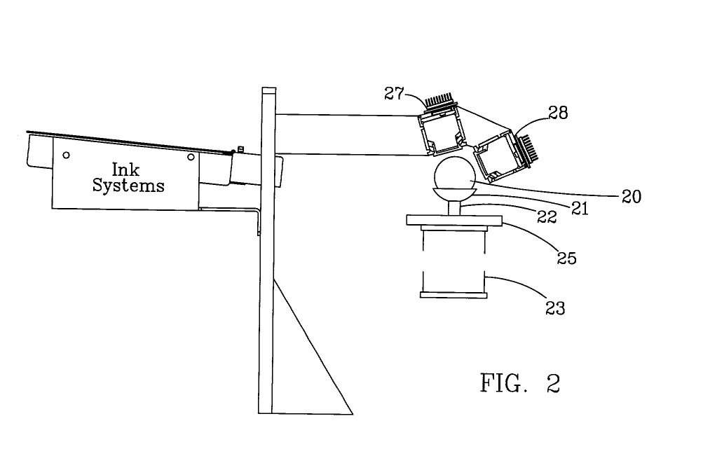

Referring to FIG. 2a, the curved object 20 is placed in the retaining cup 21 that is attached to the spindle 22. The spindle is attached to a motor 23 that, in turn, is attached to the ball pivot frame 25. Placement of the curved object 20 can be done either manually or via some automatic means, with a manual placement being the preferred method in order to avoid later printing on already present logos or other marks and, to avoid complex and expensive machinery that attempts to automatically detect existing logos or other marks.

After placement of the curved object 20, the retaining cup holds the curved object for the printing process. A variety of means for holding the curved object can be employed including a vacuum through, for example, hollow spindle shaft 22 or by means of a replaceable adhesive pad (not illustrated) nestled inside the retainer cup 21. For simplicity, use of an adhesive pad is the preferred means.

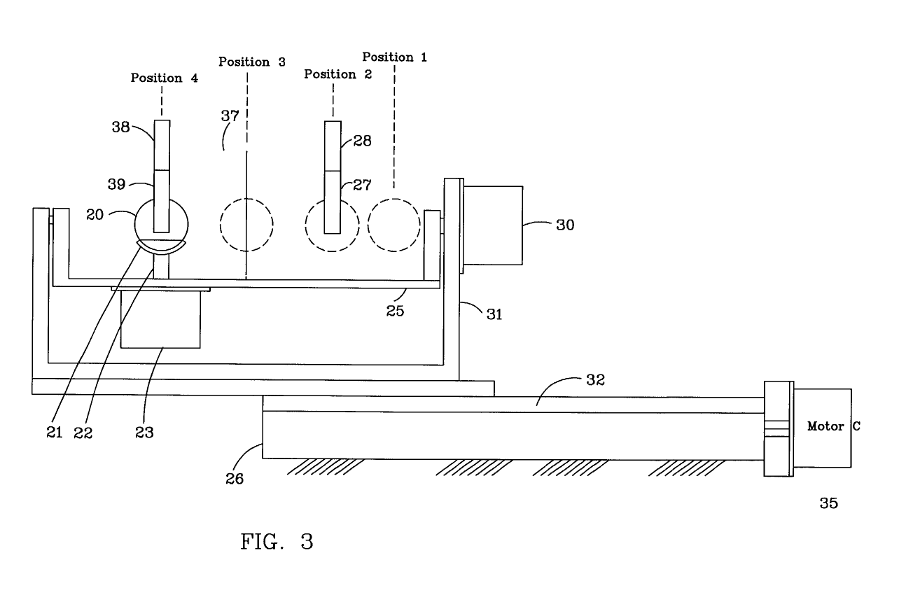

FIG. 3 is a side view showing the basic structure of part of the printing system. With curved object 20 in retainer cup 21, the operator starts the process and the motor of the precision linear slide 26 moves the curved object 20 to Position 2. Position 2, curved object is 20 centered under the two printing devices 27, 28 as illustrated in FIG. shown in FIG. 2.

At this time, the spindle motor 23 rotates the curved object at a constant angular velocity and supplies a signal indicating the curved object's angular position about axis AA to the printing controller 13 (FIG. 1). Based on this position information, the printing controller 13 causes the printing devices 27, 28 to emit droplets of ink according to the portion of the image that should be located at that angular position. One or more revolutions of the curved object will be made depending upon the layering and interleaving to be done for the particular image being printed.

At Position 2 (FIG. 3), printing devices 27, 28 are located in the approximate positions shown in FIG. 2. Each printing device 27, 28 will be dedicated to a single color as noted, for example, print device 27 may be black and device 28 may be yellow. By such a position and mounting, the process can simultaneously print with two separate colors, each in a particular area, thereby enhancing efficiency of the production.

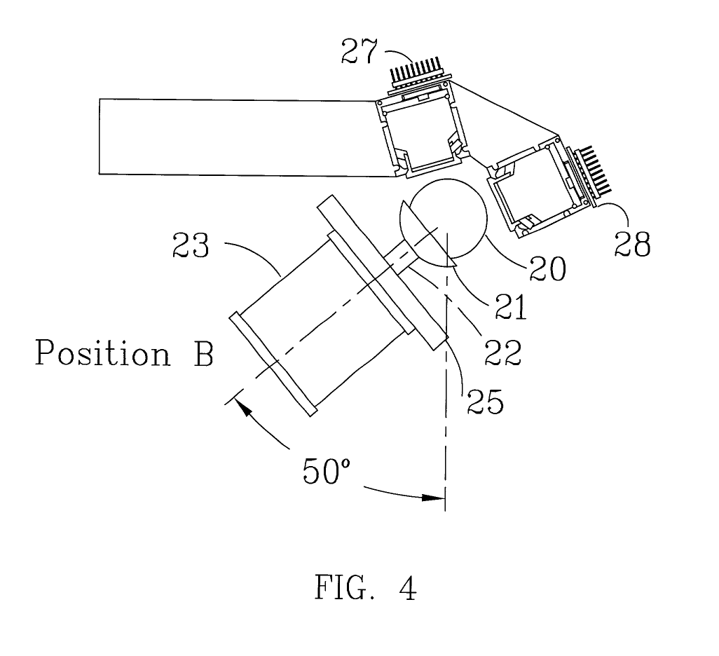

After the rotations required in Position 2 (FIG. 3), motor 30 that controls the pivot frame 25 will rotate the curved object to Position B (FIG. 4) and, in doing so, cause the two printing devices 27, 28 to have their positions exchanged relative to the image on the curved object. Hence, a second printing can be printed on all of the image area of curved object 20. Spindle motor 23 then rotates curved object 20 again through the number of revolutions required and the positional signal is used by the printer controller to print the second color over the area that was originally printed by the first color.

Optionally, the curved object may be moved from Position 2 to Position 3 at any point in the process as is required to achieve partial or complete drying or curing (under drying/curing box 37) between steps in the layering and interleaving processes. To move in such a manner will provide the ability to enhance the image quality and to allow the placement of heavier amounts of ink to improve image clarity, tone, color, and intensity.

After completion of the printing of the two colors available at Position 2, linear slide 32, powered by motor 35, will move curved object 20 to Position 3, drying station 37, where it may be dried or cured a final time before then moving to Position 4. In Position 4, two additional print heads 38, 39 with colors, for example cyan and magenta, will be added to the image on curved object 20 using the same process as described above for the first 2 colors.

It will be noted that additional positions 5, 6, etc (not illustrated) may readily be added to the process to accommodate 6 or more color printing and to allow the use of custom or spot colors at points within the image.

Upon completion of printing and drying or curing all of the colors required in the image curved object 20 will be moved to Position 1 and removed from the retainer cup 21.

FIG. 5 is an isometric view of the printing apparatus. Curved object is shown in position 4 where the final two colors are applied by ink jet heads 39 and 29. Each of the ink jet heads 27, 28, 38, 39 are suppled and controlled by the ink jet systems 41-44. Motor 35 moves bracket 31 a linearly distance under the four processing positions. The drying station 37 (position 3) is positioned between the two ink applying positions, positions 2 and 4. Motor 23, as well as retaining cup 21 and spindle 22 are on pivot frame 25. Pivot frame is mounted on frame 25a and is caused to rotate by motor 30.

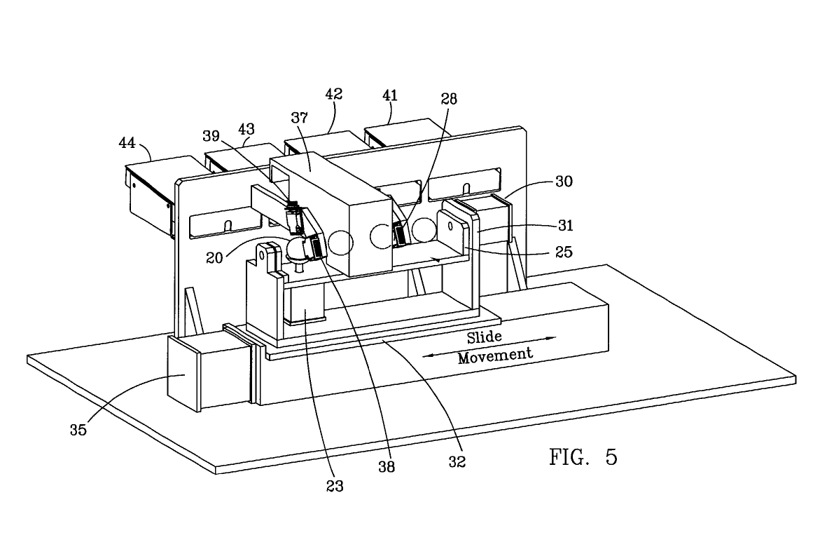

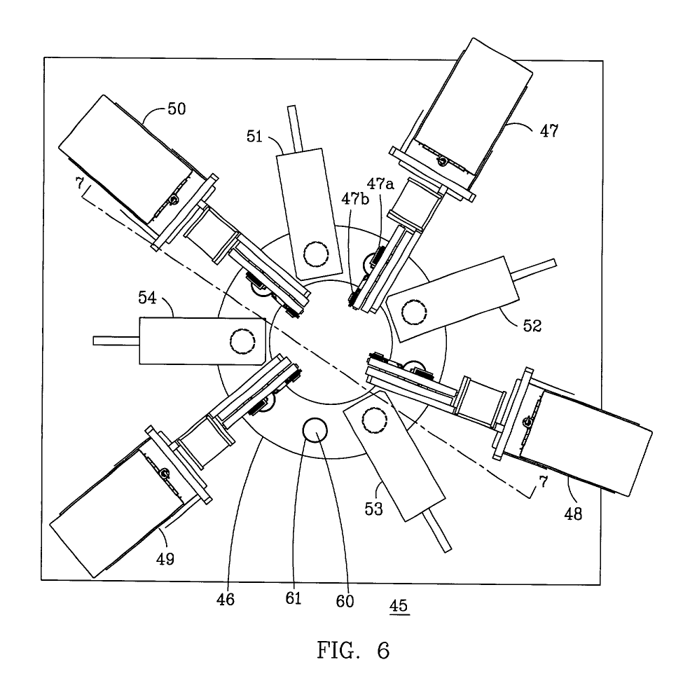

FIG. 6 illustrates a second embodiment of the invention which includes multiple print and cure/dry stations mounted on a turret. The printing device move in a arc above and partially around the curved object to which printing is applied. FIG. 6 is a top view of a nine-position turret system that allows the incremental operation of the printing process for higher volume production of the digitally image curved sports objects.

In its operation, an object is inserted into a retaining cup, for example cup 60 that is essentially the same as cup 21 shown in FIG. 2, and held in place in a similar manner.

When the operator activates a start switch, the turret motor 46a, FIG. 6 rotates the turret 46 to the first printing position, for example, the position under ink jet system 49. An encoder signal is emitted by the turret motor to the printing system controller so that the exact position of the object is precisely controlled. The rotation is approximately 1/9 of a full circle. Upon achieving the required position, turret 46 motions stops and the printing process begins.

The printing devices 47-50 are located and oriented as shown, for example, in FIG. 6 before printing starts. At this time, the spindle motor 26a rotates the curved object at a constant angular velocity and motor 26a supplies a signal indicating the curved object's angular position to the printing controller.

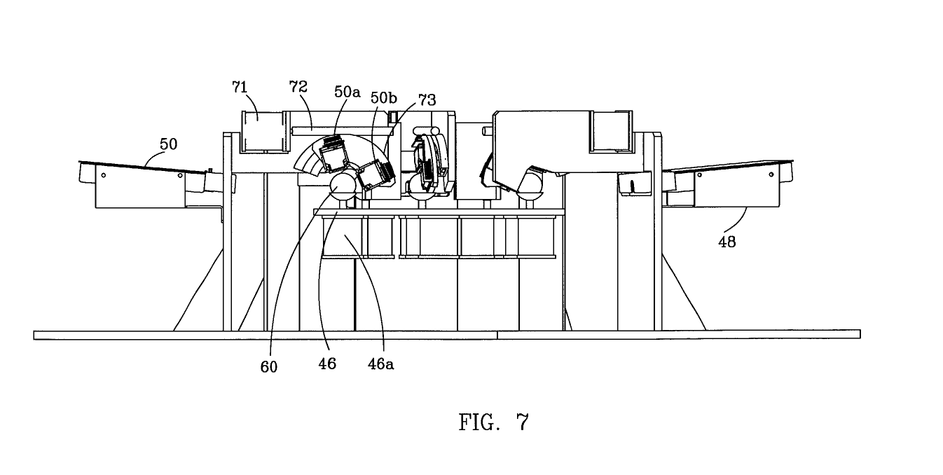

Referring now to FIG. 7, while the object 60 is rotated under a printing station, motor 71 turns the gear or worm 72 that drives the gear sector 73 which moves the printing heads 50a and 50b from their start position to their completion positions. Motor 71 emits an encoder signal to the printer controller so that the angular positions of the printing heads 50a and 50b can be precisely controlled. Based on this position information the printing controller causes the printing devices to emit droplets of ink according to the portion of the image that should be located at that angular position. One or more revolutions of curved object 60 will be made depending upon the layering and interleaving to be done for the particular image being printed. Additionally, one or more angular positions sweeps may be made by the print heads 50a and 50b, depending upon the layering and interleaving to be done for the particular image being printed.

Two printing heads, for example 50a and 50b, at each printing station are dedicated to a single color. Ink will be supplied to the printing devices from ink delivery system 50 located approximately as shown.

While the printing is being done at the first printing station, a second object will be added to the loading station 61. When the printing completes, the turret rotates to the next position and curing or drying of the first object is done simultaneously with the printing of the second object and a third object will be added to the loading station 61.

The process continues until the turret is fully loaded and each station contains an object for curing or printing. In such a manner, very rapid production of uniquely imaged objects can be achieved.

It will be noted that larger turrets with additional positions may be utilized to the accommodate and process 6 or more color printing, and to allow the use of custom or spot colors at points within the image. Two colors at each turret station may used as variation on the above-described process.

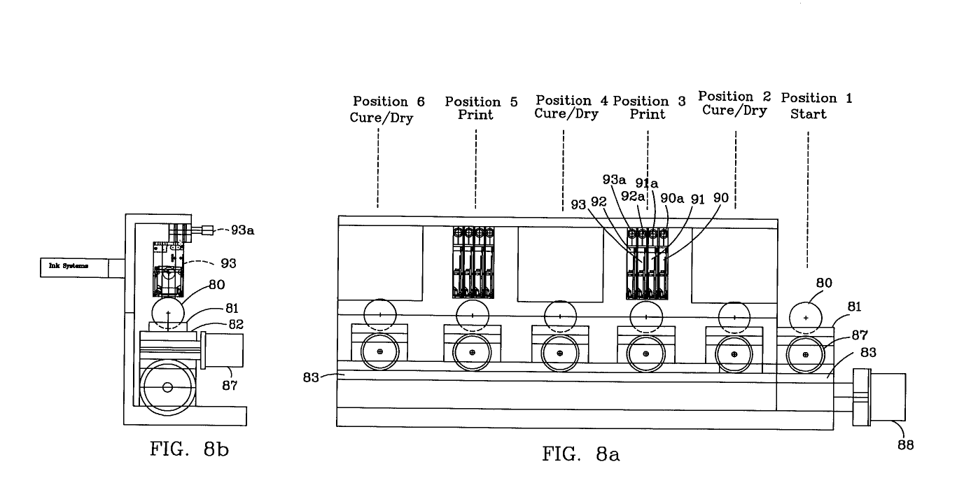

FIGS. 8a and 8b show an embodiment of the invention in which no angular motion or rotational motions are used. As a result, the image printed will not encompass the entire hemisphere of the object.

Referring to FIGS. 8a and 8b a curved object 80 is placed in the retaining cup 81 that is attached to a linear slide 82 that is fastened to another linear slide 83.

Placement of curved object 80 is done at a start Position (FIG. 8a) and is done either manually or via some automatic means, with a manual placement being the preferred method in order to avoid later printing on already present logos or other marks and, too, to avoid complex and expensive machinery that attempts to automatically detect existing logos or other marks.

After placement of the curved object 80, retaining cup 81 holds curved object 80 for the printing process. With the curved object 80 in retainer cup 81, the operator starts the process and the motor of the precision linear slide 83 moves curved object 81 to Position 2 (FIG. 8a). There may be no action at Position 2, or Position 2 can be utilized a surface pre-heating station. Curved object 80 is then passed under Position 3 where four printing devices 90, 91, 92 and 93 each sequentially print one fourth of the image from their respective color planes. The separate printing devices are precisely aligned with the alignment micrometers 90a-93a, respectively.

Object 80 then passes through Position 4 where the image is cured or dried. The system may pause at the curing and drying stations for a programmed interval depending upon the image being printed, the inks used, and the condition of the surface of the object.

Object 80 then passes under Position 5, where four additional printing devices 96-99 each sequentially print an additional one fourth of the image from their respective color planes. The object is then cured or dried at Position 6.

As the backstroke of the linear slide 83 is started, the second linear slide 82 moves object 80 perpendicular to the backstroke motion by an amount equal to one-half the jet spacing of the printing devices (90-93 and 96-99). In this way the forward and backstroke printing are interleaved. The object is then returned to the Start position after passing under each station an additional time and being printed or cured at each of these positions.

In the linear printing of FIGS. 8a and 8b, the ink jet heads will be at vary distances from the surface of object 80 since object 80 has a curved surface. To compensate for the varying distances, the ink droplet size may be varied to compensate for the spread factor for the droplets that travel a greater distance. This process is programed by the printing system 13, FIG. 1.

The linear motion for interleaving may be combined with oscillatory motion under one of the printing device clusters if this were advantageous to achieve a required image property. For example, object 80 may be rotated similarly to the way object 21 is rotated by motor 23 in FIG. 2. Also, additional clusters of printing devices and curing and drying stations may be added to FIGS. 8a, 8b to accommodate 6 or more color printing and to allow the use of custom or spot colors at points within the image.

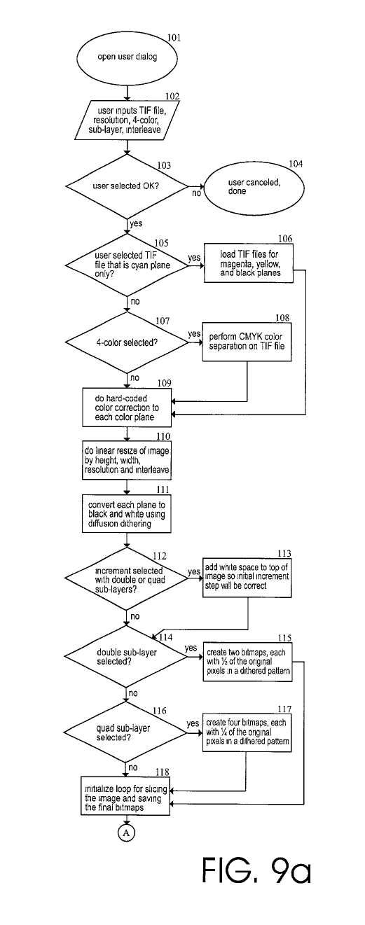

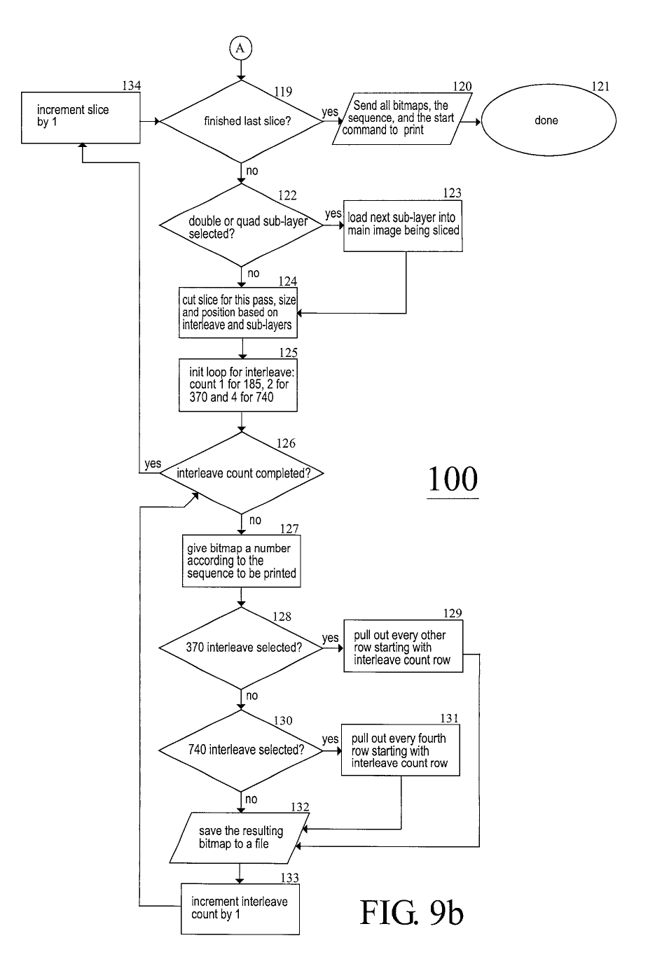

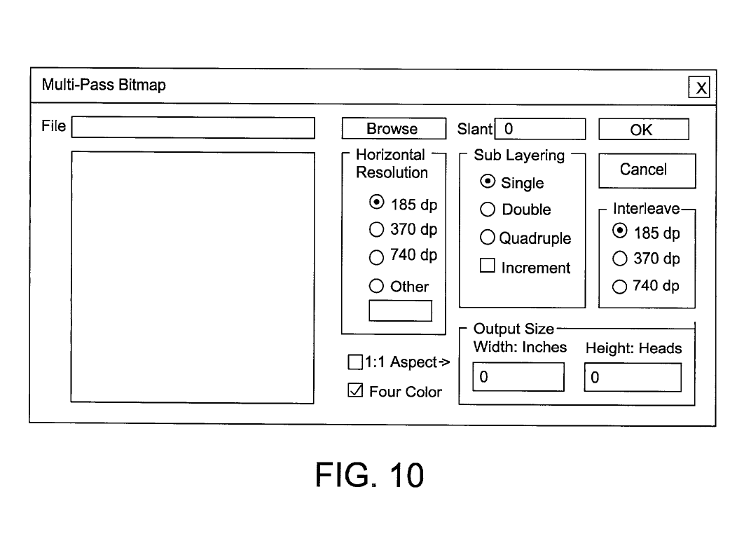

FIGS. 9a and 9b are two parts of a flow chart showing the process for preparing an image to be printed, and the instructions to the printer. The user/computer interface is shown in FIG. 10

The process for preparing the image for printing and to program the printer is designed to allow the user to select an uncompressed TIF format image file and convert it to a series of Windows bitmap files that are formatted for printing on an inkjet printer. Part of the formatting includes diffusion dithering and converting to black and white mode. The process also generates a series or sequence of files that tell the printer the order in which the bitmaps will be printed and a “message” file that acts as a signal to prepare the printer to start printing the sequence. The process then hands off the generated bitmaps, sequence of files and message file to the print system 14 (FIG. 1). An input TIF file may also be the cyan plane of a color image file that was previously CMYK separated and where each plane was saved in a separate TIF file. In this case, the process will automatically load in all four color-plane files of the image for processing.

The main dialog of the process has the appearance on the computer/user interface as illustrated in FIG. 10. This dialog contains settings that determine how the input image is to be processed for printing. A basic description of the function of each of these settings follows.

Four Color

This check box should be set if the image is to be handled as a CMYK graphic. This causes data to be sent to four print heads on the inkjet printer, one set of data for each color plane. The program will color separate an input TIF file automatically, unless the input file is the cyan plane of a pre-separated file. In that case, the other planes are loaded from their respective files automatically. If the box is left unchecked, image data will only be sent to one printhead for one color (grayscale) printing.

Horizontal Resolution and Width

These two settings work in conjunction to determine the width in pixels of the output bitmaps. The pixel width will be equal to the horizontal resolution times the width in inches. Any change in pixel width from the input file is achieved by a simple stretching or linear resizing of the image.

Interleave and Height

These two settings work in conjunction to determine the height in pixels of the final output image. That number is equal to the interleave number times the height in print heads divided by the height of one printhead in inches.

If the interleave number is set to the native resolution of the printhead of the inkjet system (for example 185) then the output bitmaps are simply produced by resizing the image's pixel height (if changed) and slicing the output image into smaller bitmaps each having the height of one printhead. The output image is then reproduced by printing a one printhead-high slice and then moving down one printhead and printing the next slice. This process is continued until the complete output image has been printed.

If the interleave number is set to multiples of the native resolution (for example 370) or 2 times the native resolution or 740 or 4 times the native resolution), then the image is resized and sliced as described above, and, in addition to that, each slice is divided into more bitmaps by taking out rows from the slice. For example, if 370 is selected, the slice is made into two bitmaps. The first contains every other row of pixels from the slice starting with the first row and the second contains the remaining rows. For example, if 740 is selected, the slice is made into 4 bitmaps. Then, each bitmap contains every forth row of the original slice, starting with rows 1, 2, 3, and 4, respectively. In this manner, all of the rows of pixels from the original slice are contained in one of the four resulting bitmaps.

The image is then to be output by printing the interleaved bitmaps of a given slice vertically offset from one another by 1/x, where x is a multiplying factor times the native printhead resolution. For example, 1/370 inch or 1/740 inch. After printing all the bitmaps associated with a given slice, the printhead is moved down by one printhead and the next slice is printed in the same way.

Sub Layering

If this option is set to “single”, then there is no effect. If it is set to “double” or “quadruple”, then the bitmaps produced by the processes described above are made into yet more bitmaps (2 bitmaps each for “double”, 4 bitmaps each for “quadruple”). The resulting bitmaps each have the same pixel dimensions as the bitmap being split. Each contains a fraction (½ for “double and ¼ for “quadruple”) of the pixels in the original bitmap in a dithered pattern on a white background. The result is such that overprinting the sub-layered bitmaps directly on top of each other reproduces the original bitmap.

One reason for doing this is to lay down less ink per printing pass to allow the ink to be dried or cured between passes. This becomes necessary when the substrate being printed on cannot accept the quantity of the ink laid down in a single printing pass without drops coalescing and forming puddles.

If the “increment” box is checked and “double” or “quadruple” is selected, then the sub-layering process is changed. In this case, the vertical position of each slice moves down by ½ of a printhead (for “double”) or one-fourth of a printhead (for “quadruple”) instead of the usual full printhead. Therefore, the printing process for “double” becomes: print the top half of the first printhead, leaving out half of the dots in a dithered pattern. Then move down half a head and fill in the remaining pixels in the top half of the head while simultaneously printing half of the pixels in the bottom half of the head. Continue this process of completing one half while starting the next half until the image is printed. The process for “quadruple” is similar: first print a quarter of the pixels in the first quarter of the top printhead. Then move down one-quarter head and print another quarter of the pixels in the first section while printing the first quarter of the pixels in the second quarter of the head. Again, move down one-quarter head. This time you will be printing another quarter of the pixels in the first two sections and the first quarter of the pixels in the third quarter of the head. Finally, move down a quarter and now you will be printing the remaining quarter of the pixels in the first section, leaving the second section three-fourths done, the third section one-half done and the newly started forth quarter head one-fourth done. This continues until the entire image is completed.

This “increment” process causes the same horizontal section of a bitmap to be completed by either two or four different sections of the physical printhead. This masks the streaking effects of missing or crooked jets in a printhead, thus improving image quality.

1:1 Aspect

If this box is checked, then any changes the user makes to the width or height fields causes a calculated change to the other dimension so that the two dimensions retain the ratio of the original image.

Slant

If a value other than 0 is entered here, then every bitmap that is output is sheared. The amount is such that, if the printhead is slanted off vertical by the slant value (in degrees), then the printed output will be restored back to the (undistorted) original image. This allows for printing at various other vertical resolutions other than those given by the interleave function.

A detailed description of the image preparation and printing process for flow diagram 100 illustrated in FIG. 9 is as follows.

The user starts the process (101) thus bringing up the main dialog box on the screen. In the main dialog, the user must select (102) a TIF graphics file, and may also select from several options that affect the way the original image will be split into bitmaps for the Eagle printer. Did the user press the “OK” button (103) or the “Cancel” button (104)? Follow the “yes” branch for “OK” or the “no” branch for “Cancel”. If “no” (104) close the dialog and terminate the program without doing anything. If “yes” (103) then proceed to 105. If the name of the TIF file loaded ends in “_C” and the “4-color” check box is checked, then the process knows that this is the cyan plane of the image only.

The magenta, yellow and black planes (106) of the image are loaded from disk files. The names of the files must be the same as the name of he cyan plane (without the “_C”) plus having the ending “_M”, “_Y” and “_K”, respectively.

Did the user check the “4-color” check box in the dialog (107)? If not, the image is treated as one plane (grayscale). If “yes” (108), the process will perform its own CMYK color separation to obtain the four color planes for processing. The process will adjust the gamma of each color plane by values that are hard-coded into the process (109). The input image is resized (110) to a width in pixels equal to the user-entered width in inches times the user-enter horizontal resolution and a height in pixels equal to the user-entered interleave times the user-entered height in print heads divided by 128/185.

Next, each plane is converted (111) to one-bit (black and white) color depth. Render “grayscale” areas of the image using a diffusion dot pattern whose density is decided by the relative darkness or lightness of the original image.

Did the user check the increment check box and select either double or quadruple interleave (112)? If yes (113), add white space to the top of the image. If double increment (114) was selected, then add half of a printhead height of white space (115), so the first pass will print only half a printhead height of the image, which will be completed on the next pass. In step (115) the process creates and stores in memory two bitmaps, one with half of the pixels from the original image in a dithered pattern on a white background, the other with the remaining pixels.

If the user selected quadruple sub-layering (116), then add three-quarters of a printhead height of white space, so the first pass will print a quarter printhead height of the image, which will be completed in the next three passes.

In step (117) the process creates and stores, in memory, four bitmaps, each one with one quarter of the pixels from the original image in a dithered pattern.

In step (118) the process initializes a “slice” counter that will start at 1. Step (119) checks if the “slice” counter has exceeded the total number of bitmaps that will be produced as output by this process divided by 1 (if interleave is 185), 2 (if interleave is 370), or 4 (if interleave is 740).

Step (120) copies all the produced bitmaps, a series of “sequence” files that will tell the printer what order to print the bitmaps in, and a “message” file that will initialize the printer to the beginning of the print sequence to a folder where the process, running in the background, will detect their presence and automatically sent them to the printer, and (121) closes the dialog and ends the program.

If step (119) is “no” then check if the user selected either double or quadruple sub-layering (122). If step (122) is yes, then sequentially cycle (123) through the 2 (if double) or 4 (if quadruple) bitmaps that were stored in memory in (115) or (117). Use these bitmaps, instead of the original, for the source when performing operations for producing the output bitmap for this “slice”.

In step (124), select a region, or “slice”, of the source image to cut out to produce the output bitmap(s) for this iteration of the slice loop. The size will be equal to 128 (if 185 interleave is selected), 256 (if 370 interleave is selected) or 512 (if 740 interleave is selected). The vertical position of the top of the slice in relation to the entire source image will change each time through the “slice” loop by one printhead height (if single sub-layer is selected, one half printhead height (if double sub-layer increment is selected), or one-quarter printhead height (if quadruple sub-layer increment is selected). If increment is not selected, then the position will change by one printhead every two iterations of the “slice” loop (if double sub-layer is selected) or every four iterations of the “slice” loop (if quadruple sub-layer is selected). Step (125) initializes a loop for interleave. The interleave count starts at 1 and will finish if greater than 1 (if interleave is 185), 2 (if interleave is 370), or 4 (if interleave is 740).

In step (126) check to see if the interleave counter exceeded the number of interleave bitmaps? If ‘no’ then Generate a bitmap number (127). Each output bitmap will be saved with the original name with the last three characters changed to a number such as “001”, 002”, etc. the number corresponds to the order in which they will be printed. Step (128), did the user select 370 interleave? If yes, get every other row of pixels from the source bitmap by offsetting the bitmap by the interleave counter minus 1 and doing a vertical liner resize to one-half of the vertical size of the slice (129). If “no”, did the user select 740 interleave (130)?

If 740 interleave is selected, then get every forth row of pixels from the source bitmap by offsetting the bitmap by the interleave counter minus 1 and doing a vertical liner resize to one-quarter of the vertical size of the slice (131).

The output bitmap is then saved to disk (132). The interleave counter is then incremented the by one (133). The “slice” counter is then incremented the by one (134).

What is claimed:

1. A method for sending and possessing an image from a person to an internet web site and relaying the image via a high speed data link to a machine for printing the image on an object having a curved surface, comprising the steps of:
processing the digital image to prepare it for printing;
sending the digital image via at least one of the internet and a high speed data link to an inkjet printing device, using an automated process to prepare a spherical sports object to receive the image onto its surface;
inkjet printing the image on the surface of the object in a programmable and variable sequence; and
drying and curing the image during intermediate steps of the inkjet printing process, and post-treating the inkjet image on the spherical object.

2. The method according to claim 1, wherein said object with a curved surface is mounted on a rotatable spindle.

3. The method according to claim 1, wherein the processing of the digital image includes separating the image into digital layers and sub-layers to allow the selection of an image printing process to conceal malfunction of individual jet ins the inkjet printing process.

4. The method according to claim 1, wherein the surface of the object is treated with at least cleaners and sealers to optimize the inkjet print quality.

5. The method according to claim 1, the digital image is separated into digital layers and sub-layers to allow the image to be printed in a variable sequence that optimizes drying and color quality.

6. The method according to claim 1, wherein the digital images are printed one color at a time in interchangeable sequences as necessary for optimum image quality.

7. The method according to claim 1, including the step of preparing the curved surface for printing by applying at least one of a corona treatment, plasma discharge and solvent bath to the surface, and post treating the printed surface by applying at least one of sealers, varnishes, lacquers, and UV protective coating to optimize the print quality and durability of the inkjet image on the curved surface.

8. The method according to claim 1, including the step of separating the image into digital layers and sub-layers that can be altered mathematically to alter the image so that it can be printed on a curved surface without visual distortion.

9. A apparatus for printing images on an object with a curved surface comprising:
at least one inkjet printing head;
a support with a base on which the object with the curved surface is mounted;
at least one drying station for drying the ink applied to the curved surface; and
transfer means for moving the support and base on which the curved surface is mounted to position under the inkjet printing head and the drying station.

10. The apparatus according to claim 9, wherein including two inkjet printing heads mounted on a rotatable device that maintains the print heads at a uniform distance from the object with the curved surface.

11. The apparatus according to claim 9 including a plurality of inkjet printing heads, each printing with an ink of a different color.

12. The apparatus according to claim 9, wherein said transfer means is a rotatable table for moving the object with a curved surface under different inkjet printing heads and drying stations.

13. The apparatus according to claim 9, wherein said transfer means moves the object with a curved surface linearly along a straight line adjacent to each inkjet printing head and drying station.

14. The apparatus according to claim 16, wherein each inkjet printing head is programmed to dispense ink in a manner correlated upon the distance an inkjet nozzle is from the curved printing surface.

15. A method for printing an image on a curved surface, comprising the steps of:
determining the number of colors to be printed to form the image;
separating color images into image files when more than one color is to be used;
resize the image for resolution and interleave of color layers;
select the number of layers to be printed to form the image;
slice each image layer for multi-pass printing; and
print each layer in multi-passes until the image is complete.

16. The method according to claim 18, including the step of creating x multiple bitmaps from the original that each contain 1/x of the original pixels of the image in a dithered pattern.
